(19) United States
(12) Patent Application Publication
(10) Pub. No.: US 2025/0148334 A1
(43) Pub. Date: May 8, 2025

(54) CIRCUIT CUTTING WITH REAL-TIME TELEMETRY AND SERVICE-LEVEL OBJECTIVES

(71) Applicant: Dell Products L.P., Round Rock, TX (US)

(72) Inventors: Victor Fong, Medford, MA (US); Brendan Burns Healy, Haddonfield, NJ (US); Benjamin E. Santaus, Somerville, MA (US); Miguel Paredes Quiñones, Campinas (BR); Rômulo Teixeira de Abreu Pinho, Niterói (BR)

(21) Appl. No.: 18/345,370

(22) Filed: Jun. 30, 2023

Related U.S. Application Data
(60) Provisional application No. 63/383,317, filed on Nov. 11, 2022.

(51) Int. Cl. G06N 10/40

(52) U.S. Cl. CPC G06N 10/40

(57) ABSTRACT

Cutting quantum circuits is disclosed. Probability distributions for quantum circuit parameters are generated from historical quantum circuit data. When cutting the quantum circuit, the probability distributions are sampled to obtain a set of initial circuit parameters that can function as constraints in the cutting operation.

### FIELD OF THE INVENTION

Embodiments of the present invention generally relate to quantum computing and to orchestrating quantum workloads. More particularly, at least some embodiments of the invention relate to systems, hardware, software, computer-readable media, and methods for cutting quantum circuits while accounting for telemetry data and service level objectives.

### BACKGROUND

Executing quantum circuits in quantum computing systems can be both complicated and time consuming for a variety of different reasons. For example, the quantum circuit may be too large for available quantum hardware. Further, even if the necessary quantum hardware exists, the quantum circuit may need to wait until the resources are free.

More specifically, several difficulties exist with regard to quantum computing. When using real quantum hardware, the number of qubits is often limiting and, from a practical perspective, cannot execute quantum circuits with more qubits. Further, larger quantum hardware (comparatively more qubits) may be less accurate compared to quantum hardware with fewer qubits.

There are also problems associated with simulated quantum systems. As the complexity of a quantum circuit increases (e.g., more qubits required), the amount of resources required in the simulated quantum system increases exponentially. These issues complicate the ability to effectively and efficiently use quantum computing systems, whether real or simulated.

Further, executing the quantum circuit in a quantum computing system is preceded and/or followed by various operations that may also consume substantial amounts of computing resources and time. For example, prior to executing a quantum circuit, a cutting operation may be performed to cut the quantum circuit into smaller quantum circuits. When the cutting operation is performed, a knitting operation is necessary to knit the results of the various executions together to determine a result for the original quantum circuit.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1 discloses aspects of orchestrating the execution of quantum jobs and of executing quantum jobs;

FIG. 2 discloses additional aspects of executing a quantum job;

FIG. 3 discloses aspects of generating probability distributions for quantum circuit patterns that are used in a cutting operation; and

FIG. 4 discloses aspects of a method for cutting a quantum circuit using circuit parameters sampled from one or more probability distributions.

### DETAILED DESCRIPTION OF SOME EXAMPLE EMBODIMENTS

Embodiments of the present invention generally relate to real and/or simulated quantum computing systems and to operations performed when executing quantum workloads. More particularly, at least some embodiments of the invention relate to systems, hardware, software, computer-readable media, and methods for orchestrating quantum jobs (i.e., quantum workloads) that may include quantum circuit(s). More specifically, embodiments of the invention relate to cutting quantum circuits into quantum subcircuits (each a quantum circuit on its own) in a manner that accounts for real-time (or most recent) telemetry data and/or service level objectives.

Quantum circuits may be executed in simulated quantum systems (e.g., virtual quantum systems or units (vQPUs)) that include classical computing components (e.g., processors, memory) or real quantum hardware systems or units (QPUs). More specifically, the execution of quantum jobs often requires both classical computing systems and quantum computing systems because several operations are performed. Some of the operations are performed in classical computing systems and some of the operations are performed in quantum computing systems, whether real or simulated. Embodiments of the invention relate to orchestrating the operations performed in classical computing systems and in quantum computing systems.

Quantum computing systems have limitations on the depth of the quantum circuit and the number of qubits that can be accommodated. Circuit cutting is an orchestration task or operation that is performed when a quantum circuit cannot run on a quantum system, whether real or virtual, or for other reasons such as to improve performance. The cutting operation allows the execution of large quantum circuits across different quantum systems. More specifically, the cutting operation allows multiple quantum hardware and/or simulation engines (QPUs and vQPUs) to execute large quantum circuits by cutting the original quantum circuit into smaller quantum circuits (quantum subcircuits). The quantum subcircuits can be executed sequentially on a particular quantum computing system, in parallel using multiple quantum computing systems, or combinations thereof.

In one example, a quantum job, which includes a quantum circuit, may be received at an orchestration engine that is configured to orchestrate the execution of the quantum job. Orchestrating the execution of the quantum circuit includes performing actions or operations such as, but not limited to, transpilation operations, cutting operations, and knitting operations. These operations are orchestrated as necessary and in the appropriate order.

Embodiments of the invention perform and/or orchestrate a cutting operation to cut a quantum circuit into smaller quantum circuits or quantum subcircuits using knowledge (e.g., telemetry data) of available quantum systems in which the quantum subcircuits may be executed. This knowledge includes, for example, the maximum qubit count that each quantum computing system can execute, resource availability/in use, and the service level objectives for the quantum circuit, which may include budget, time, accuracy, and other requirements.

Because a quantum circuit can be represented as a directional acyclic graph (DAG), the cutting operation, in accordance with embodiments of the invention, turns these inputs (e.g., available qubits, telemetry data, service level objectives) into constraints for a mixed-integer programming (MIP) algorithm used for traversing DAG.

However, these inputs may not be available at the time of developing the quantum circuit or at the time of cutting the quantum circuit. Embodiments of the invention relate to a platform that can automatically provide these inputs to the circuit cutting operation or to the orchestration engine, so that the cutting operation or output of the circuit cutting operation is adjusted to account for the target quantum system itself and a specific time (e.g., time of or near the time of quantum circuit execution) or other factors.

Resource availability and service-level objectives impact the constraints of the MIP algorithm used for cutting the quantum circuit. These inputs, however, may not be available at development time. As a result, the cutting operation conventionally relies on a best guess. Consequently, the circuit cutting operation may not be tailor-fitted to the real-time environment. This often results in inefficiencies and may result in failure to run or execute the quantum circuits.

Without real-time telemetry information, platforms and developers often perform the MIP algorithms of the circuit cutting operation in a sequential manner. For example, the circuit cutting operation may try to cut the quantum circuit with a maximum qubit count of 28, only to realize that the resources (e.g., the classical and/or quantum computing systems) cannot execute 28 qubits. Thus, the circuit cutting operation may try a similar approach with 27 qubits. This approach is very time-consuming and inefficient.

Even with real-time telemetry, the quantum subcircuits cut from the original quantum circuit may not satisfy user defined service-level objectives. For example, a subcircuit may require 35 qubits and an HPC (High Performance Computing) environment to execute the simulation, while the user does not have the budget. In this example, the circuit cutting operation would need to be executed again to obtain a different cutting configuration.

Embodiments of the invention relate to modelling the relationship between real time telemetry, service level objectives, and/or circuit parameters. Embodiments of the invention relate to a probabilistic approach that allows a probability distribution to be probed, using the real time telemetry data and/or the service level objectives, to obtain initial circuit parameters for the cutting operation, which may use the MIP algorithm.

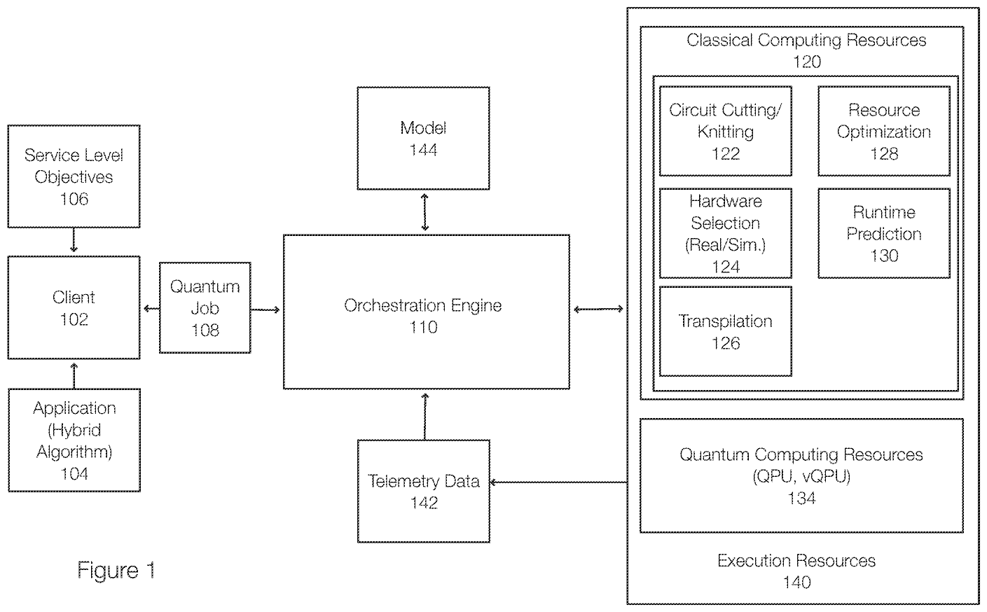

FIG. 1 discloses aspects of orchestrating a quantum job. In one example, a quantum job may be generated by a hybrid application 104. The hybrid application 104, in one example, is an application that may require the use of execution resources 140, which may include both classical computing resources 120 and quantum computing resources 134. The orchestration of the quantum job 108 may be performed by an orchestration engine 110 and as previously stated, some aspects of the quantum job may be executed in classical computing systems and other aspects may be executed in quantum environments (simulated or real).

When the quantum computing resources 134 are required, the hybrid application 104 may generate and submit a quantum job 108 to the orchestration engine 110. Results of executing the quantum job 108 may be returned to the client 102. Other aspects of the hybrid application 104 that do not require the quantum computing resources 134 may be performed in the classical computing resources 120 with or without the aid of the orchestration engine.

In FIG. 1, a client 102 (e.g., a computing device that may receive user input) may submit a quantum job 108, which may be associated with service level objectives 106 and a hybrid application 104, to an orchestration engine 110. The orchestration engine 110 is configured to orchestrate the execution of the quantum job 108 in accordance with the service level objectives 106.

The actions or operations orchestrated by the orchestration engine 110 may include circuit cutting/knitting 122 operations, resource optimization 128 operations, hardware selection 124 operation, runtime prediction 130 operations, transpilation 126 operations, or the like or combination thereof. The orchestration engine 110 may have access to execution resources 140, which may include the classical computing resources 120 (e.g., servers, nodes, containers, clusters, virtual machines) that include processors, memory, and the like. The execution resources 140 may also include the quantum computing resources 134 (real or simulated).

Orchestrating the execution of the quantum job 108 may include managing the stages of executing the quantum job 108. In effect, the orchestration engine 110 may guide the quantum job 108 through a quantum pipeline such that the output of each stage is directed to the input of the next stage. Examples of stages or operations that may be performed on a quantum job include cutting, transpilation, quantum execution, knitting, resource optimization, runtime prediction, or the like or combinations thereof.

Once the quantum circuit or quantum subcircuits of the quantum job 108 are prepared for execution, these quantum circuits are deployed to or placed in the quantum computing resources 134, which may be simulated or real. The results of executing the quantum circuits in the quantum computing resources 134 may also be collected by the orchestration engine 110 and returned to the client 102.

When the orchestration engine 110 is performing, by way of example, a cutting operation, the orchestration engine 110 may use the service level objectives 106 and the telemetry data 142 to access a model 144 to obtain circuit cutting parameters. This allows the service level objectives and/or the telemetry data to be constraints for the cutting operations.

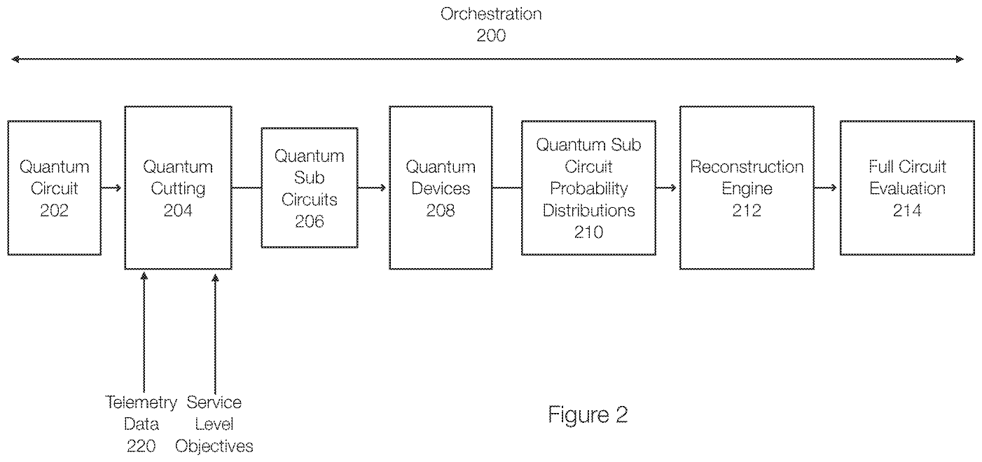

FIG. 2 discloses aspects of orchestrating the execution of a quantum circuit and illustrates examples of orchestration actions or operations. In FIG. 2, an orchestration engine performs orchestration 200 that may be performed from receipt of a quantum job or circuit to providing results of executing the quantum circuit. A quantum circuit 202 is provided to quantum cutting 204. When cutting the quantum circuit 202 at quantum cutting 204, a cutting decision 220 is performed.

As illustrated in FIG. 2, a circuit cutting engine may perform quantum cutting 204 in a manner that considers the telemetry data 220 and service level objectives 222. The telemetry data 220 may include, by way of example, resource consumption telemetry data such CPU (central processing unit or processor) usage, memory usage, GPU (Graphics Processing Unit) usage, GPU memory usage, or the like. The service level objectives 222 may include, by way of example, cost, execution time, accuracy, or the like. The service level objectives 222 may also specify types of quantum hardware (e.g., real or simulated), location (geography) or the like or combinations thereof.

More specifically, if the quantum circuit 202 is to be cut, the telemetry data 220 and the service level objectives 222 can be used to probe a probability distribution for circuit parameters used to cut the quantum circuit 202.

Cutting 204 the quantum circuit 202 generates quantum subcircuits 206 that are executed at quantum devices 208 (real or simulated). Once the quantum subcircuits 206 are generated, runtime prediction may be performed on each of the quantum subcircuits 206 such that resource optimization 222 can be performed. Once an execution plan is generated that reflects the resource optimization, the quantum subcircuits 206 are submitted to the quantum devices 208 (real and/or simulated) in accordance with the execution plan. The outputs of the executions may include quantum subcircuit probability distributions 210, which are distinct from the probability distribution(s) associated with the circuit parameters.

Executing a quantum circuit is often performed by executing the circuit in a quantum device for a predetermined number of shots. The output is a collection of shot results which reflect an underlying probability distribution. Thus, the outputs of executing the quantum subcircuits includes the probability distributions 210.

Next, a knitting operation is performed by a reconstruction engine 212. The reconstruction engine 212 combines the outputs (e.g., the various probability distributions) of executing the quantum subcircuits 206 to determine the output (the probability distribution) of the original quantum circuit 202. This allows an evaluation 214 of the full or original quantum circuit to be performed. The results or evaluation can be returned to the client or to the hybrid application.

Embodiments of the invention further relate to a probabilistic approach that models the relationship between real time (or most recently available) telemetry data, service-level objectives and circuit cutting parameters. In preparing the model to determine the probability distributions, embodiments of the invention collect a set of data that includes information related to the execution of quantum circuits. The quantum circuits represented in the set of data represent multiple different executions.

For each executed quantum circuit, the following data is collected and included in the set of data uses as a training dataset:
parameters of the circuit, c, that are relevant for the cutting operation (e.g., number of qubits and circuit depth);
resource consumption telemetry, t, during the execution of the circuit (e.g., CPU usage, main memory usage, GPU usage, GPU memory usage); and
service-level objective metrics (SLO), s (e.g., execution time)

From the collected data or the training dataset, a discrete, conditional, joint probability distribution p (C|T, S), where C, T, S represent the random variables for circuit parameters, telemetry, and SLO metrics, respectively, is modeled. In one embodiment, all of the parameters in c are independent and the following simplification can be performed:

$$p ( C \vert T , S ) = {\prod }_{{c}_{i} ∈ c} p ( {c}_{i} \vert T , S )$$

This simplification allows the distribution of each circuit parameter to be modeled independently. In one embodiment, a separate conditional probability distribution may be modeled for each parameter of interest.

When a new quantum circuit is to be executed and cut prior to execution, the orchestration engine obtains real-time telemetry, t, of all execution environments, across on-premises and cloud, which may include QPU and vQPU environments. The orchestrator obtains SLO constraints, s, provided by the user (e.g., maximum execution time, budget). If the orchestration engine deems that the circuit needs to be cut to fit the quantum infrastructure (be it real quantum hardware or classical infrastructure running quantum simulation engines) or cut for other reasons (e.g., improving performance), the orchestration engine may probe the probability distribution model to obtain an initial set of circuit cutting parameters for the MIP algorithm.

The orchestration engine determines if the circuit needs to be cut by, for instance, by comparing the number of qubits of the circuit with the maximum number of qubits available on the target quantum computing system. If the quantum circuit (or quantum subcircuit from the cutting) is to be executed on a simulation engine, the orchestrator may obtain resource consumption estimates from characteristics of the quantum circuit. The orchestration engine can then compare the estimates with the available resources on the simulation engine.

An initial set of cutting parameters may be obtained by calculating their expected values from the modelled probability distribution(s). With the assumption that the parameters are independent, each parameter, ĉₗ, may be computed or determined as follows:

ĉᵢ=Σcᵢⱼ*p(cᵢⱼ|t,s)=E[cᵢ],

where cᵢⱼ are the possible values of parameter cᵢ.

Estimates of each parameter, ĉᵢ, are then assembled into a parameter vector, ĉ, and passed as input to the cutting operation. The MIP algorithm can turn these parameters into constraints used when cutting the quantum circuit to create quantum subcircuits that can satisfy the user defined service-level objectives.

For example, if there is only one QPU available that can support 100 qubits, but the user only has budget to execute one quantum circuit on such a quantum system, a constraint on the MIP would be to cut only one subcircuit with 100 qubits. The rest of the quantum subcircuits would be small enough to run on other, less expensive quantum computing systems. Alternatively, it may be the case that a 30 qubit QPU has a 1-hour queue for new quantum jobs, while a 28 qubit QPU is available immediately. In this case, it may be advantageous, in order to meet SLO requirements, to cut quantum circuits to a max width of 28 qubits instead of 30.

Embodiments of the invention thus use real-time telemetry and service level objectives as constraints for cutting quantum circuits. This is distinct from entering static parameters that do not consider SLO requirements or current telemetry data.

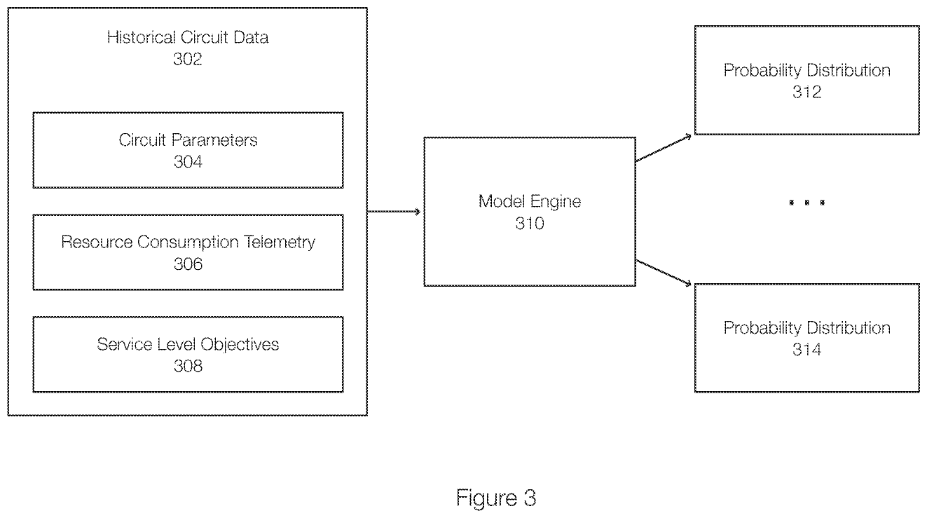

FIG. 3 discloses aspects of generating probability distributions. In FIG. 3, historical circuit data 302 is collected. The historical circuit data 302 is related to quantum circuits that have been executed in quantum computing systems, whether real or simulated. For example, the circuit parameters 304 may include parameters such as number of qubits and circuit depth. The resource consumption telemetry 306 may include information related to resource usage such as CPU usage, memory usage, GPU usage, GPU memory usage, or the like. In other words, the resources consumed by the execution of the quantum circuit are collected and stored in the historical circuit data 302. The service level objectives 308 includes SLO metrics such as execution time, cost, or the like. Thus, each quantum circuit represented in the historical circuit data 302 is represented across the circuit parameters 304, the resource consumption telemetry 306, and the service level objectives.

A model engine 310 may receive or access the historical circuit data 302 as input and generate multiple probability distributions, represented as probability distributions 312 and 314. The probability distribution 312 may be related to a qubit parameter and the probability distribution 314 may be related to circuit depth parameter.

When the real time (or most recent) telemetry data is acquired and the service level objectives are available, the probability distributions can be sampled to generate initial values for the circuit parameters used in the cutting operation. If necessary, the probability distributions 312 and 314 may be sampled more than one time in the course of cutting the quantum circuit. For example, the circuit parameters obtained from the first sample may fail or be insufficient and, as a result, a second sample may be performed.

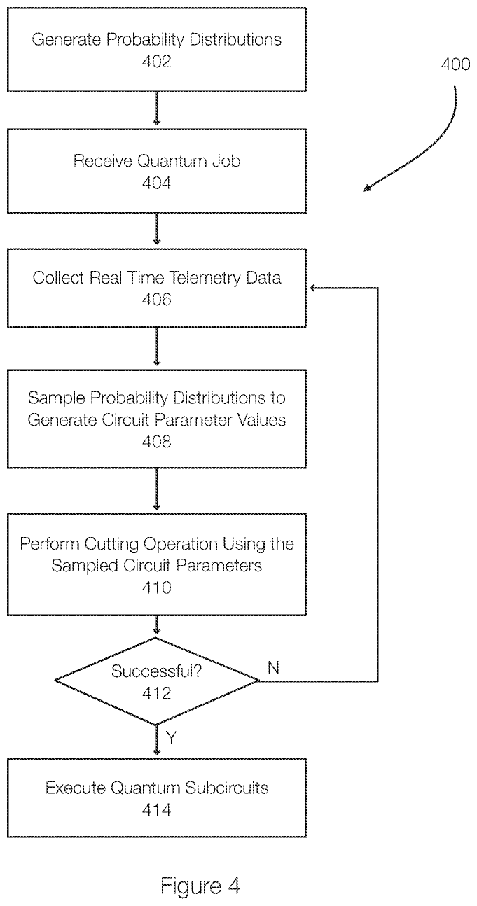

FIG. 4 discloses aspects of a method for performing a cutting operation. The method 400 may include acts of steps that may be performed independently of other acts or steps and/or at different frequencies. The method 400, for example, includes generating 402 probability distributions from historical circuit data. This may be performed as an initial step. The probability distributions may be updated over time as additional circuit data is collected.

In the method 400, a quantum job is received 404 by an orchestration engine. The quantum job may include a quantum circuit and the orchestration engine may orchestrate the execution of the quantum circuit. The method 400 assumes that the orchestration engine has determined that the quantum circuit should be cut into smaller quantum circuits.

Before cutting the quantum circuit, real time telemetry data is collected 406. The collected data may include real-time (or most recent) telemetry data from the computing resources (classical and quantum) available to the orchestration engine. As previously stated, service level objectives for the received quantum job are also available.

Next, the probability distributions are sampled 408 using the collected data to obtain a set of circuit parameters (e.g., number of qubits and circuit depth). The set of circuit parameters sampled from the probability distributions may function as constraints. With the set of circuit parameters sampled from the probability distributions, the cutting operation is performed 410 to obtain quantum subcircuits that can be executed in selected or target quantum computing systems.

If the cutting operation is successful (Y as 412), the resulting quantum subcircuits are executed 414 (other steps such as transpilation may be required prior to circuit execution). If the cutting operation is not successful using the initial set of circuit parameters (N at 412), new samples are obtained from the probability distribution as previously described using the real time (or most recent) information.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods, processes, and operations, are defined as being computer-implemented.

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, hybrid-classical application operations, quantum circuit operations, quantum circuit execution operations, quantum circuit cutting operations, resource consumption estimation operations, quantum circuit knitting operations, telemetry operations, machine learning model operations (e.g., that generate predictions or inferences), modelling operations, probability distribution related operations, sampling operations, or the like or combination thereof. These operations may, in some examples, be referred to as quantum operations.

Example cloud computing environments, which may or may not be public, include storage environments that may provide functionality for one or more clients or systems. Another example of a cloud computing environment is one in which quantum operations and/or quantum services may be performed on behalf of one or more clients, applications, or users. Some example cloud computing environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of cloud computing environment. The cloud environment may also include quantum environments including vQPUs, QPU, other accelerators, or the like.

In addition to the cloud environment, the operating environment may also include one or more clients that are capable of collecting, modifying, and creating, data. As such, a particular client may employ, or otherwise be associated with, one or more instances of each of one or more applications that perform such operations with respect to data or circuits. Such clients may comprise physical machines, containers, or virtual machines (VMs).

Particularly, devices in the operating environment, such as classical components of hybrid classical-quantum systems, may take the form of software, physical machines, containers, or VMs, or any combination of these, though no particular device implementation or configuration is required for any embodiment. Similarly, data storage system components such as databases, storage servers, storage volumes (LUNs), storage disks, replication services, backup servers, restore servers, backup clients, and restore clients, for example, may likewise take the form of software, physical machines, containers, or virtual machines (VM), though no particular component implementation is required for any embodiment.

It is noted that any operation(s) of any of these methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments of the invention. These are presented only by way of example and are not intended to limit the scope of the invention in any way.

Embodiment 1. A method comprising: receiving a quantum circuit at an orchestration engine, collecting data that includes telemetry data for execution environments and service level objectives associated with the quantum circuit, sampling a probability distribution using the collected data to obtain at least one circuit parameter from the probability distribution, and cutting the quantum circuit into quantum subcircuits using the at least one parameter.

Embodiment 2. The method of embodiment 1, further comprising generating historical circuit data that includes circuit parameters, resource consumption telemetry, and service level objectives related to the execution of multiple quantum circuits in diverse quantum computing systems.

Embodiment 3. The method of embodiment 1 and/or 2, further comprising generating the probability distribution from the historical circuit data.

Embodiment 4. The method of embodiment 1, 2, and/or 3, wherein the at least one circuit parameter includes a number of qubits and/or a circuit depth.

Embodiment 5. The method of embodiment 1, 2, 3, and/or 4, wherein the probability distribution includes a first probability distribution for a first circuit parameter related to the number of qubits and a second probability distribution for a second circuit parameter related to the circuit depth.

Embodiment 6. The method of embodiment 1, 2, 3, 4, and/or 5, wherein the telemetry data includes one or more of processor usage, memory usage, GPU (graphics processing unit) usage, GPU memory usage and wherein the service level objectives include execution time, accuracy, and/or budget.

Embodiment 7. The method of embodiment 1, 2, 3, 4, 5, and/or 6, further comprising generating a vector that includes the at least one circuit parameter.

Embodiment 8. The method of embodiment 1, 2, 3, 4, 5, 6, and/or 7, further comprising cutting the quantum circuit using the at least one parameter in the vector as constraints to create the quantum subcircuits.

Embodiment 9. The method of embodiment 1, 2, 3, 4, 5, 6, 7, and/or 8, wherein the at least one parameter are independent of each other.

Embodiment 10. The method of embodiment 1, 2, 3, 4, 5, 6, 7, 8, and/or 9, wherein the probability distribution is a conditional probability distribution, further comprising resampling the probability distribution to obtain a second set of circuit parameters if cutting the quantum circuit based on the at least one circuit parameter fails and cutting the quantum circuit using the second set of circuit parameters.

Embodiment 11. A method for performing any of the operations, methods, or processes, or any portion of any of these, or any combination thereof disclosed herein.

Embodiment 12. A non-transitory storage medium having stored therein instructions that are executable by one or more hardware processors to perform operations comprising the operations of any one or more of embodiments 1-12.

Embodiment 13. A system comprising a processor and memory configured to perform the operations, methods, or processes, or any portion of any of these, or any combination thereof disclosed herein.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general-purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, engine, or agent, may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

Any one or more of the entities disclosed, or implied, herein, may take the form of, or include, or be implemented on, or hosted by, a physical computing device, As well, where any of the aforementioned elements comprise or consist of a virtual machine (VM) or a container, that VM or container may constitute a virtualization of any combination of the physical components disclosed herein.

In a physical computing device includes a memory which may include one, some, or all, of random-access memory (RAM), non-volatile memory (NVM) such as NVRAM for example, read-only memory (ROM), and persistent memory, one or more hardware processors, non-transitory storage media, UI device, and data storage. One or more of the memory components of the physical computing device may take the form of solid-state device (SSD) storage. As well, one or more applications may be provided that comprise instructions executable by one or more hardware processors to perform any of the operations, or portions thereof, disclosed herein. The physical device may be an example of a classical computing system that may be part of a hybrid computing system. A quantum processing system or unit may also be included in the hybrid computing system.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising;
receiving a quantum circuit at an orchestration engine;
collecting data that includes telemetry data for execution environments and service level objectives associated with the quantum circuit;
sampling a probability distribution using the collected data to obtain at least one circuit parameter from the probability distribution; and
cutting the quantum circuit into quantum subcircuits using the at least one parameter.

2. The method of claim 1, further comprising generating historical circuit data that includes circuit parameters, resource consumption telemetry, and service level objectives related to the execution of multiple quantum circuits in diverse quantum computing systems.

3. The method of claim 2, further comprising generating the probability distribution from the historical circuit data.

4. The method of claim 1, wherein the at least one circuit parameter includes a number of qubits and/or a circuit depth.

5. The method of claim 4, wherein the probability distribution includes a first probability distribution for a first circuit parameter related to the number of qubits and a second probability distribution for a second circuit parameter related to the circuit depth.

6. The method of claim 1, wherein the telemetry data includes one or more of processor usage, memory usage, GPU (graphics processing unit) usage, GPU memory usage and wherein the service level objectives include execution time, accuracy, and/or budget.

7. The method of claim 1, further comprising generating a vector that includes the at least one circuit parameter.

8. The method of claim 1, further comprising cutting the quantum circuit using the at least one parameter in the vector as constraints to create the quantum subcircuits.

9. The method of claim 8, wherein the at least one parameter are independent of each other.

10. The method of claim 1, wherein the probability distribution is a conditional probability distribution, further comprising resampling the probability distribution to obtain a second set of circuit parameters if cutting the quantum circuit based on the at least one circuit parameter fails and cutting the quantum circuit using the second set of circuit parameters.

11. A non-transitory storage medium having stored therein instructions that are executable by one or more hardware processors to perform operations comprising:
receiving a quantum circuit at an orchestration engine;
collecting data that includes telemetry data for execution environments and service level objectives associated with the quantum circuit;
sampling a probability distribution using the collected data to obtain at least one circuit parameter from the probability distribution; and
cutting the quantum circuit into quantum subcircuits using the at least one parameter.

12. The non-transitory storage medium of claim 11, further comprising generating historical circuit data that includes circuit parameters, resource consumption telemetry, and service level objectives related to the execution of multiple quantum circuits in diverse quantum computing systems.

13. The non-transitory storage medium of claim 12, further comprising generating the probability distribution from the historical circuit data.

14. The non-transitory storage medium of claim 11, wherein the at least one circuit parameter includes a number of qubits and/or a circuit depth.

15. The non-transitory storage medium of claim 14, wherein the probability distribution includes a first probability distribution for a first circuit parameter related to the number of qubits and a second probability distribution for a second circuit parameter related to the circuit depth.

16. The non-transitory storage medium of claim 11, wherein the telemetry data includes one or more of processor usage, memory usage, GPU (graphics processing unit) usage, GPU memory usage and wherein the service level objectives include execution time, accuracy, and/or budget.

17. The non-transitory storage medium of claim 11, further comprising generating a vector that includes the at least one circuit parameter.

18. The non-transitory storage medium of claim 11, further comprising cutting the quantum circuit using the at least one parameter in the vector as constraints to create the quantum subcircuits.

19. The non-transitory storage medium of claim 18, wherein the at least one parameter are independent of each other.

20. The non-transitory storage medium of claim 11, wherein the probability distribution is a conditional probability distribution, further comprising resampling the probability distribution to obtain a second set of circuit parameters if cutting the quantum circuit based on the at least one circuit parameter fails and cutting the quantum circuit using the second set of circuit parameters.
